(19) United States
(12) Patent Application Publication
(10) Pub. No.: US 2015/0112297 A1
(43) Pub. Date: Apr. 23, 2015

(54) QUICK RELEASE VIAL ADAPTER

(71) Applicant: MEDIMOP Medical Projects Ltd., Ra'anana (IL)

(72) Inventors: Nimrod Lev, Savion (IL); Amir Lev, Kfar Saba (IL)

(73) Assignee: MEDIMOP Medical Projects Ltd., Ra'anana (IL)

(21) Appl. No.: 14/391,792

(22) PCT Filed: Apr. 10, 2013
(86) PCT No.: PCT/IL2013/050316

§ 371 Date: Oct. 10, 2014

(30) Foreign Application Priority Data
Apr. 17, 2012 (IL) 219222

(51) Int. Cl. A61J 1/20

(52) U.S. Cl. CPC A61J 1/2089; A61J 2001/201; A61J 2001/2048
USPC 604/414

(57) ABSTRACT

Vial adapters including a skirt having a transverse directed top surface and a pair of opposite downward depending snap fit flex members each integrally formed with an inward directed ridge for telescopically snap fitting onto a vial opening and an upright finger grip extension. Manual inward urging of the pair of opposite finger grip extensions towards one another flexes the pair of opposite snap fit flex members at the top surface such that their pair of opposite inwardly directed ridges are outwardly urged from one another thereby releasing a previously snap fitted drug vial.

### FIELD OF THE INVENTION

The invention relates to vial adapters.

### BACKGROUND OF THE INVENTION

Vial adapters include a skirt having a transverse directed top surface and one or more pairs of opposite resiliently flexible flex members downward depending therefrom for telescopically receiving a vial opening of a drug vial, a downward depending central puncturing cannula for puncturing a vial stopper for flow communication with a drug vial interior and an opposite directed vial adapter port in flow communication with the central puncturing cannula. Some skirts include one or more pairs of opposite interference fit flex members which interference fit a vial opening. Other skirts include one or more pairs of opposite snap fit flex members each formed with an inwardly directed ridge for snap fitting onto a vial opening. Removal of vial adapters with snap fit flex members from a drug vial requires a user to firm hold a drug vial in one hand and use his other hand to lever the vial adapter off the drug vial. Some users can find such removal cumbersome.

### SUMMARY OF THE INVENTION

The present invention is directed toward vial adapters intended for quick release from a drug vial. The quick release vial adapters of the present invention have a hitherto described construction including a pair of opposite snap fit flex members. The quick release vial adapters of the present invention additionally provision each snap fit flex member with an upright finger grip extension with respect to their transverse directed top surface. Manual inwards urging of the pair of opposite finger grip extensions towards one another flex their snap fit flex members such that their pair of opposite inwardly directed ridges are outwardly urged from one another thereby releasing a previously snap fitted drug vial. The quick release vial adapters of the present invention can optionally include one or more additional pairs of opposite interference fit flex members and a vent arrangement including a dual lumen puncturing cannula and vent ports.

### BRIEF DESCRIPTION OF DRAWINGS

In order to understand the invention and to see how it can be carried out in practice, a preferred embodiment will now be described, by way of a non-limiting example only, with reference to the accompanying drawings in which similar parts are likewise numbered, and in which:

FIG. 1 is a front top perspective view of a quick release vial adapter;

FIG. 2 is a front bottom perspective view of the vial adapter;

FIG. 3 is a front elevation view of the vial adapter telescopically snap fitted on a drug vial;

FIG. 4 is a longitudinal cross section of FIG. 3 along line A-A in FIG. 1;

FIG. 5 is a front elevation view showing manual operation of the vial adapter to release the drug vial; and

FIG. 6 is a longitudinal cross section of FIG. 5 along line A-A in FIG. 1.

### DETAILED DESCRIPTION OF PREFERRED EMBODIMENT OF THE INVENTION

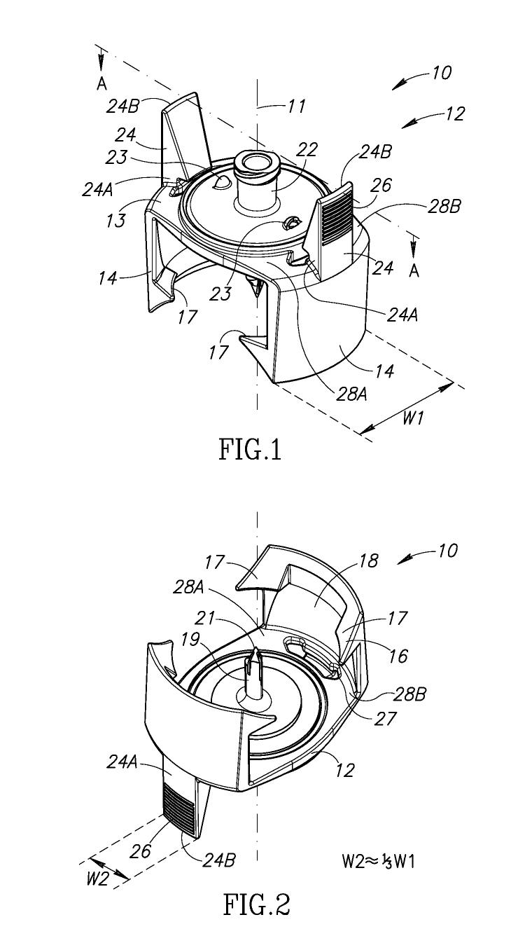

FIGS. 1 to 6 show a quick release vial adapter 10 for use with a drug vial 40 including a vial bottle 41 having a vial opening 42 and a vial stopper 43 for sealing the vial opening 42. The vial adapter 10 has a longitudinal vial adapter axis 11 and includes a skirt 12 with a transverse directed top surface 13 and a pair of opposite snap fit flex members 14 resiliently flexibly downward depending therefrom. The snap fit flex members 14 each have a peripheral width W1 slightly smaller than a quarter circumference of the top surface 13.

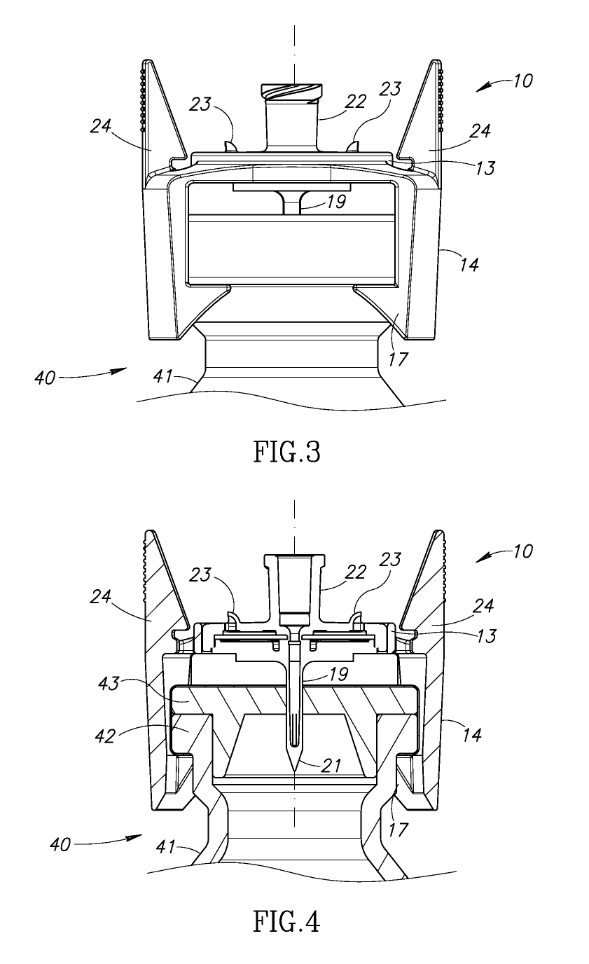

The snap fit flex members 14 are each integrally formed with an inwardly directed ridge 16 for telescopically snap fitting on a vial opening 42 (see FIGS. 3 and 4). Each inwardly directed ridge 16 includes a pair of spaced apart protrusions 17 separated by a cutaway 18 such that the vial adapter 10 employs two opposite pairs of spaced apart protrusions 17 for telescopically snap fitting onto a vial opening 42.

The vial adapter 10 includes a downward depending puncturing cannula 19 terminating at a puncturing tip 21 for puncturing a vial stopper 43. The vial adapter 10 includes an opposite directed vial adapter port 22 which is typically but not necessarily a female Luer connector. The puncturing cannula 19 includes a dual lumen arrangement having a first lumen in flow communication with the vial adapter port 22 and a second lumen in flow communication with a pair of vent ports 23 formed in the top surface 13.

The snap fit flex members 14 are additionally integrally formed with a pair of wedge shaped finger grip extensions 24 oppositely directed thereto with respect to the top surface 13. The wedge shaped finger grip extensions 24 have bases 24A tapering towards free ends 24B correspondingly adjacent and remote from the top surface 13. The finger grip extensions 24 are centrally disposed relative to the flex members 14 and have a peripheral width W2 wherein W1>W2. The snap fit flex members 14 are preferably at least twice as wide as their finger grip extensions 24 and more preferably three times as wide. The exterior surfaces of the finger grip extensions' free ends 24B are formed with uppermost non-slip ridged external surfaces 26 for improved gripping.

The top surface 13 is formed with a pair of concave slits 27 at the finger grip extensions' bases 24A facing towards the longitudinal vial adapter axis 11 such that the snap fit flex members 14 downwardly depend from the top surface 13 at peripheral top surface bridge sections 28A and 28B lateral to the concave slits 27. The concave slits 27 assist flexing of the snap fit flex members 14 relative to the top surface 13 which in practice occurs at the top surface bridge sections 28A and 28B.

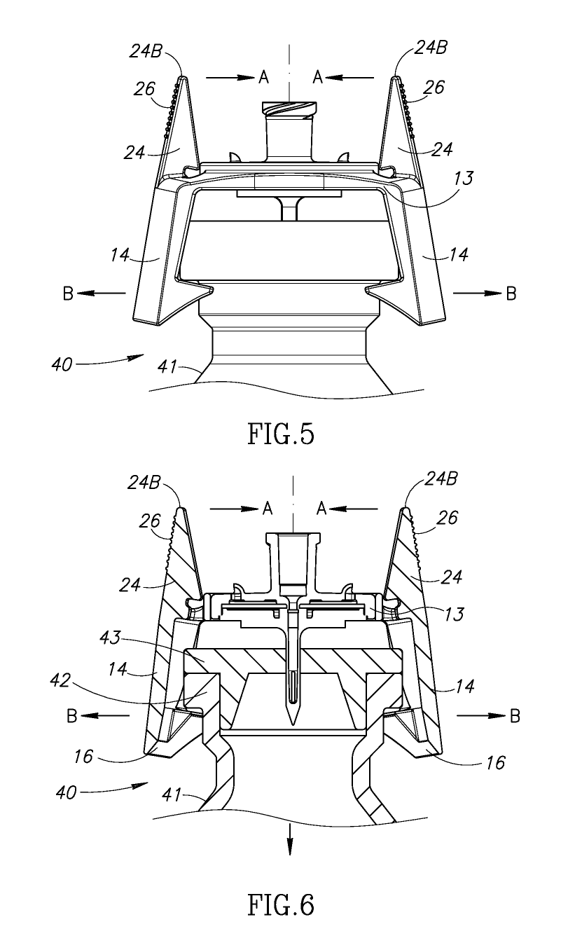

Manual inward urging of the pair of opposite finger grip extensions' free ends 24B towards one another denoted by arrow A flexes the pair of opposite snap fit flex members 14 at the top surface bridge sections 28A and 28B for outwardly urging the pair of opposite inwardly directed ridges 16 from one another denoted by arrow B in FIGS. 5 and 6 thereby releasing a previously snap fitted drug vial 40.

While the invention has been described with respect to a limited number of embodiments, it will be appreciated that many variations, modifications, and other applications of the invention can be made within the scope of the appended claims.

1-5. (canceled)

6. A vial adapter for use with a drug vial including a vial bottle having a vial opening and a vial stopper for sealing the vial opening, the vial adapter including a longitudinal vial adapter axis and comprising:
a skirt including a transverse. directed top surface having at least two flex members resiliently flexibly downward depending therefrom for telescopically mounting on the vial opening,
said at least two flex members including a pair of opposite snap fit flex members each having an inwardly directed ridge for snap fitting onto the vial opening and an upright finger grip extension oppositely directed thereto relative to said top surface,
each said finger grip extension having a base and a free end correspondingly adjacent and remote from said top surface;
a puncturing cannula downward depending from said transverse directed top surface for puncturing the vial stopper on telescopically mounting said skirt on the vial opening; and
a vial adapter port upwardly depending from said transverse directed top surface and in flow communication with said puncturing cannula,
the arrangement being such that manual inward urging of said pair of free ends of said pair of opposite finger grip extensions toward one another flexes said pair of opposite snap fit flex members at said top surface for outwardly urging said pair of opposite inwardly directed ridges from one another for releasing a previously snap fitted drug vial,
wherein said top surface is formed with a concave slit adjacent said base of each said finger grip extension facing towards said longitudinal vial adapter axis for assisting said flexing of said pair of opposite snap fit flex members.

7. The adapter according to claim 6, wherein each said inwardly directed ridge includes a pair of spaced apart protrusions for snap fitting onto the vial opening.

8. The adapter according to claim 6, wherein each said finger grip extension is wedge shaped tapering from its said base to its said free end.

9. The adapter according to claim 6, wherein each said snap fit flex member is at least twice as wide as its said finger grip extension.
